(19) United States
(12) Patent Application Publication
(10) Pub. No.: US 2018/0141091 A1
(43) Pub. Date: May 24, 2018

(54) ELECTROMAGNETIC PIG FOR OIL AND GAS PIPELINES

(71) Applicant: The Board of Regents of The University of Texas System, Austin, TX (US)

(72) Inventor: Mukul M Sharma, Austin, TX (US)

(21) Appl. No.: 15/575,062

(22) PCT Filed: May 11, 2016
(86) PCT No.: PCT/US16/31776

§ 371 Date: Nov. 17, 2017

Related U.S. Application Data
(60) Provisional application No. 62/164,157, filed on May 20, 2015.

(51) Int. Cl. B08B 7/00; B08B 9/055; B08B 9/051; F16L 53/34; F16L 55/38

(52) U.S. Cl. CPC B08B 7/0071; B08B 9/0553; F16L 2101/12; F16L 53/34; F16L 55/38; B08B 9/051

(57) ABSTRACT

Described herein are methods and system that use electromagnetic heating to heat pipelines, flowlines and the fluids therein. The heating is achieved by placing one or more permanent magnets in the wellbore and moving a metallic component and/or one or more permanent magnets relative to each other. This generates eddy currents in the metallic component or the pipeline wall, which heat the metallic component or pipeline wall and the fluids therein. The relative motion between the magnets and the metallic component is driven by the fluid pressure that drives the pig through the pipeline.

### BACKGROUND OF THE INVENTION

### 1. Field of the Invention

The invention generally relates to methods of generating heat in oil or gas pipelines and flowlines using electromagnetic heating.

### 2. Description of the Relevant Art

Oil and its byproducts play a major role in today's industries. Oil is typically removed from wells and transported through pipelines. Depending on the location of a well and the desired destination of the oil, such pipelines may be on the ground or at the sub-sea level.

The flow of oil through a pipeline can lead to the buildup of different substances which tend to impede the fluid flow. For instance, there may be a buildup of scale, paraffin wax, gas hydrates, debris or sand in the pipeline as the oil flows through it. The deposition of paraffin or hydrates on the walls of oil and gas pipelines (both onshore and offshore) results in reduced flow or plugging.

To mitigate this problem pigging is routinely conducted on such pipelines. “Pigs” are mechanical devices that are driven by fluid pressure through the pipeline and are designed to scrape the wells of the pipeline. Pigs pass through the pipeline removing paraffin and other deposits ahead of them as they are pushed through the pipeline. Typically, a pig will have some sort of abrasive device coupled to the outer surface which scrapes the deposits from the pipeline wall as the pig is passed through the pipeline.

A heat source, in theory, could be used to enhance removal of the low melting paraffin deposits. Providing heat throughout a substantially length of pipeline using standard heating methods would require that electrical power be transmitted over hundreds of feet pipe. The high cost of maintenance and set-up of a pipeline heating system, as well as the cost of supplying sufficient energy to heat an extended length of pipeline, makes other methods of providing heat to pipeline desirable.

### BRIEF DESCRIPTION OF THE DRAWINGS

Advantages of the present invention will become apparent to those skilled in the art with the benefit of the following detailed description of embodiments and upon reference to the accompanying drawings in which:

FIGS. 1-5 depict embodiments of an electromagnetic pig having a rotatable array of permanent magnets;

FIGS. 6-9 depict embodiments of an electromagnetic pig that uses an array of permanent magnets to induce heat in a metallic component which forms a portion of the exterior surface of the pig;

FIGS. 10-13 depict embodiments of an electromagnetic pig having a rotatable metallic component which rotates about an array of permanent magnets;

FIGS. 14-16 depict embodiments of a sealed pig that includes an electromagnetic heating system; and

FIG. 17 depicts an embodiment of a pig having high velocity fluid jets directed at the pipeline wall.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

The following description generally relates to systems and methods for removing deposits from oil and gas pipelines.

“Hydrocarbons” are generally defined as molecules formed primarily by carbon and hydrogen atoms. Hydrocarbons may also include other elements such as, but not limited to, halogens, metallic elements, nitrogen, oxygen, and/or sulfur. Hydrocarbons may be, but are not limited to, natural gas, gas hydrates, kerogen, bitumen, pyrobitumen, oils, natural mineral waxes, and asphaltenes. Hydrocarbons may be located in or adjacent to mineral matrices in the earth. Matrices may include, but are not limited to, sedimentary rock, sands, sandstones, carbonates, diatomites, and other porous media. “Hydrocarbon fluids” are fluids that include hydrocarbons. Hydrocarbon fluids may include, entrain, or be entrained in non-hydrocarbon fluids such as hydrogen, nitrogen, carbon monoxide, carbon dioxide, hydrogen sulfide, water, and ammonia.

“Paraffin hydrocarbons” or “Paraffins” refer to any of the saturated hydrocarbons having the general formula CₙH₂ₙ₊₂, C being a carbon atom, H a hydrogen atom, and n, an integer greater than 15. Paraffins having more than 15 carbon atoms per molecule are generally solids at or about room temperature and can form solid deposits in wellbores as the produced fluid cools when being conveyed to the surface.

In one embodiment, the problems of the prior art may be mitigated by generating heat in pigs used in oil or gas pipelines, using electromagnetic heating. The heating is accomplished by placing one or more cylindrical tubes which have an array of magnets placed on their surface in a pipeline pig and rotating these tubes inside the pipe. The change in the magnetic field as the magnetic cylinders rotate will induce currents in the pipe and cause heating as the pig moves through the pipeline.

The energy needed to spin the magnetic cylinder is provided by the fluid pressure that is used to drive the pig through the pipeline. The fluid pressure drives a turbine inside the pig or connected to the pig that induces rotation of the magnetic cylinders relative to the pipeline wall resulting in heat generation that will heat up both the walls of the pipeline and the fluids/paraffin in the pipeline ahead of the pig.

The basic idea of induction heating induced by rotation of an array of magnets inside the pipeline can have many embodiments. Some design features include:
Different turbine designs;
Different designs for connecting the turbine to the rotating magnets or a rotating metal cylinder with stationary magnets;
Magnetic array could be inside the pig, in front of it or behind it;
Rotation of the magnets could be heating the pipeline or the pig itself;
Magnets could be stationary and a metal cylinder rotated around the magnets to create the heat;

Induction heating is generally produced by moving premanent magnets with respective to a conductive metal to generate eddy currents in the conductive metal, causing the temperature of the conductive metal to increase. The permanent magnets may be installed in many different ways. Some examples of permanent magnet arrays include:
1. Cylindrical arrangement of alternately placed north-south poles of permanent magnets.
2. A linear array of North-South poles of permanent magnets.
3. A cylindrical or linear Hallbach array of magnets

The primary mechanism used to drive the turbine is to use the fluid pressure differential or a high fluid velocity stream impinging on the turbine blades to rotate the turbine blades which in turn can rotate the array of magnets to generate the heat needed to warm up the pig, pipeline and/or the fluids in it.

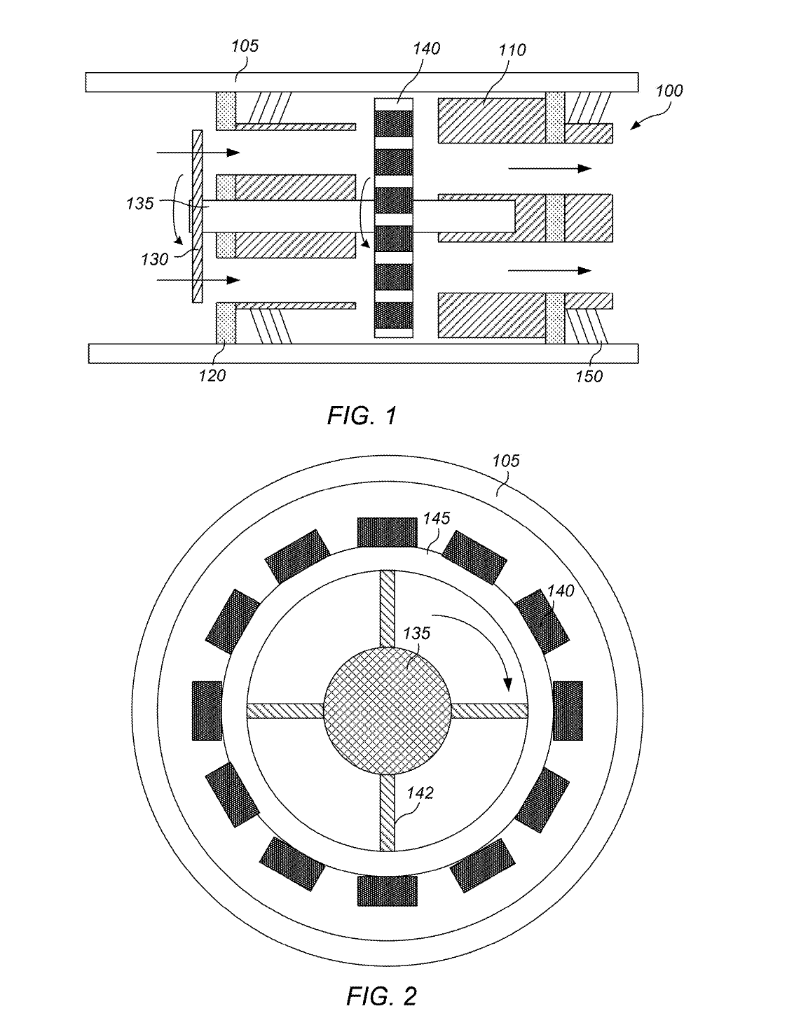

FIG. 1 depicts an embodiment of a pig 100 for removing deposits from a pipeline wall 105 that includes an electromagnetic heating system. Pig 100 includes a housing 110 and one or more annular elements 120 circumferentially mounted to the housing. The one or more annular elements engage the interior walls of pipeline 105 forming a substantially fluid impermeable seal between the pig and the pipeline, allowing a fluid differential to build between the upstream (back) of the pig and the downstream (front) of the pig. This fluid differential provides a motive force which propels the pig through the pipeline. A pig also includes one or more cleaning devices 150 coupled to an exterior of the housing and positioned such that the cleaning devices contact the pipeline wall 105. Cleaning devices 150 scrape deposits off the pipeline wall as the pig travels through the pipeline.

A turbine 130 is coupled to pig 100. In the embodiment depicted in FIG. 1, turbine 130 is placed on the upstream (back) side of the pig. A turbine, as used herein, is a rotary device that converts kinetic and potential energy of moving fluids into mechanical work. In the embodiments described herein the turbines are driven by fluids flowing through the pipeline (e.g., oil or natural gas). Many different types of turbines can be used to drive the electromagnetic heating system. The flow of fluid can be directed on to the blades of the turbine, creating a force on the blades. In this way, kinetic energy is transferred from the fluid flow to the turbine blade.

Two types of turbines that may be used include reaction turbines and impulse turbines. In reaction turbines the fluid pressure changes as it moves through the turbine and gives up its energy. Such turbines must operate in an enclosed system (such as a pipeline) to contain the pressure. Most reaction turbines are used in low (<30 m, <100 ft) and medium (30-300 m, 100-1000 ft) head applications. Impulse turbines change the velocity of a fluid jet that impinges on the turbine blades. The jet pushes on the turbine's curved blades which are designed to change the direction of the flow. The resulting change in momentum causes a force on the turbine blades. The shape of turbine blades can be adjusted based on the water pressure and the type of impeller selected. Impulse turbines are often used in very high (>300 m/1000 ft) head applications. Turbine selection for electromagnetic heating of pigs is based, at least partially, on the flow rate of fluid through the pipeline and the pressure difference across the pig driving the pig through the pipeline. In general, impulse turbines are preferred for high pressure drops and reaction turbines for low pressure drops.

Turbine 130 is coupled to one or more permanent magnets 140. A drive system is used to couple the turbine to the permanent magnets. In an embodiment, a drive system includes an axle 135 that couples the one or more permanent magnets to turbine 130. Permanent magnets 140, in one embodiment, may be coupled to an annular ring 145, as shown in FIG. 2. One or more connecting members 142 couple axle 135 to annular ring 145. In this manner, the rotational energy produced by the turbine is transferred to annular ring 145, causing magnets 140 to be rotated within the pig.

As depicted in FIGS. 1 and 2, fluid flows through turbine 130 causing the turbine to rotate. The rotation of the turbine causes rotation of the magnets 130 via axle 135. In the embodiment depicted in FIG. 1, annular ring 145 has a diameter that will bring the magnets close to the pipeline walls. Specifically, the magnets are close enough to the pipeline wall to induce eddy currents in the pipeline when the magnets are rotated. The eddy currents cause an increase in temperature of the pipeline walls, which in turn increases the temperature of the fluids contained in the pipeline.

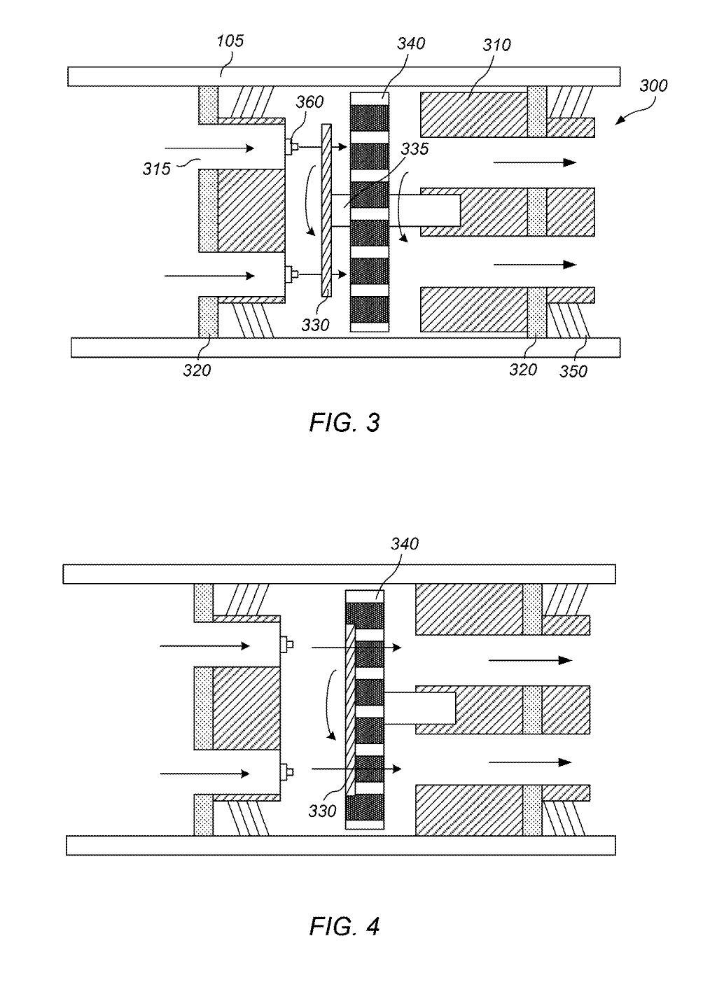

FIG. 3 depicts an alternate embodiment of a pig. Pig 300 includes a housing 310 and one or more annular elements 320 circumferentially mounted to the housing. The one or more annular elements engage the interior walls of pipeline 105 forming a substantially fluid impermeable seal between the pig and the pipeline, allowing a fluid differential to build between the upstream (back) of the pig and the downstream (front) of the pig. A pig also includes one or more cleaning devices 350 coupled to an exterior of the housing and positioned such that the cleaning devices contact the pipeline wall 105. Cleaning devices 350 scrape deposits off the pipeline wall as the pig travels through the pipeline.

A turbine 330 is coupled to pig 300. In the embodiment depicted in FIG. 3, turbine 330 is placed within the pig. One or more passages 315 are formed in the housing 310. Fluid travelling through the pipeline enters the pig through the one or more passages. The fluid may be passed through a nozzle or jet 360 to impart a high velocity to the fluid. Thus the fluid that impinges on the turbine blade is at a high velocity causing the turbines to rotate at a higher rotational velocity

As depicted in FIG. 3, fluid flows through turbine 330 causing the turbine to rotate. The rotation of the turbine causes rotation of the magnets 330 via axle 335. In the embodiment depicted in FIG. 3, the annular ring (which carries the magnets, not shown) has a diameter that will bring the magnets close to the pipeline walls. Specifically, the magnets are close enough to the pipeline wall to induce eddy currents in the pipeline when the magnets are rotated. The eddy currents cause an increase in temperature of the pipeline walls, which in turn increases the temperature of the fluids contained in the pipeline.

In some embodiments, a drive system coupling the turbine to the magnets is not needed. In the embodiment, depicted in FIG. 4, turbine 330 and the one or more permanent magnets 340 are integrated together. In an exemplary embodiment, turbine 330 has a smaller diameter than an annular ring which carries magnets 340. The turbine may be contacted with the annular ring of magnets such that rotation of the turbine directly causes rotation of the magnets without the need of an axle or other type of mechanical linkage. In one embodiment, an annular ring may not be used, with the magnets being placed on an outer surface of turbine 330.

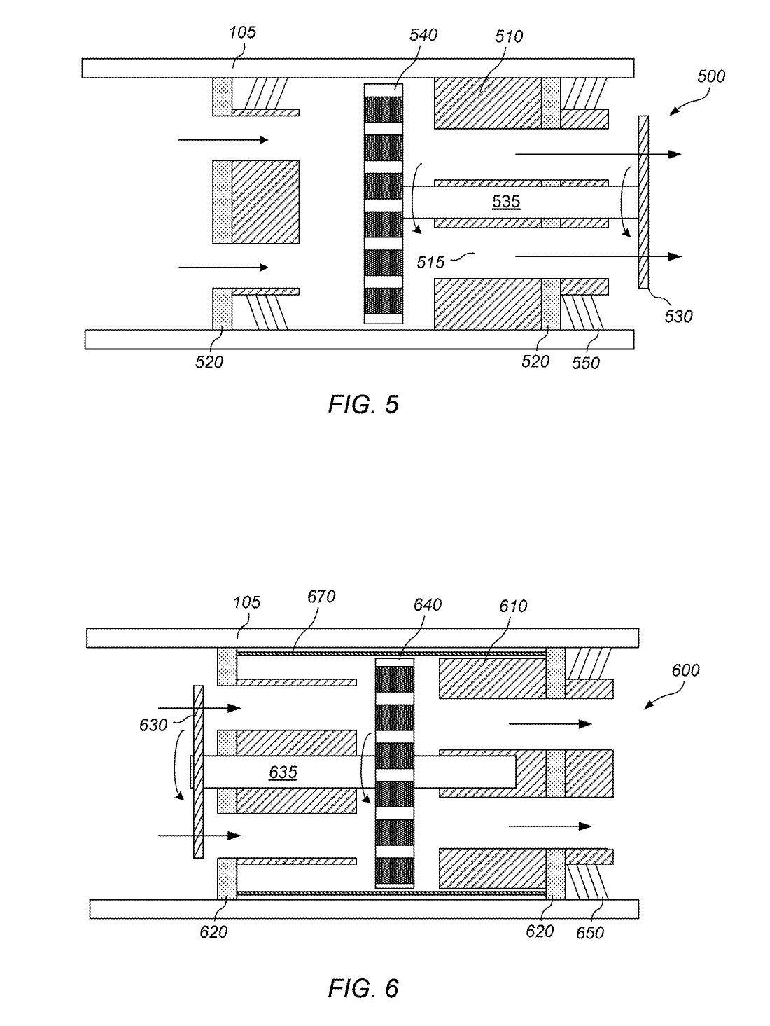

FIG. 5 depicts an alternate embodiment of a pig. Pig 500 includes a housing 510 and one or more annular elements 520 circumferentially mounted to the housing. The one or more annular elements engage the interior walls of pipeline 105 forming a substantially fluid impermeable seal between the pig and the pipeline, allowing a fluid differential to build between the upstream (back) of the pig and the downstream (front) of the pig. A pig also includes one or more cleaning devices 550 coupled to an exterior of the housing and positioned such that the cleaning devices contact the pipeline wall 105. Cleaning devices 550 scrape deposits off the pipeline wall as the pig travels through the pipeline.

A turbine 530 is coupled to pig 500. In the embodiment depicted in FIG. 5, turbine 530 is placed downstream (in front of) the pig. One or more passages 515 are formed in the housing 510. Fluid travelling through the pipeline enters the pig through the one or more passages. Fluid flowing through the one or more passages exits the pig at a velocity sufficient to cause turbine 530 to turn.

As depicted in FIG. 5, fluid flows through turbine 330 causing the turbine to rotate. The rotation of the turbine causes rotation of the magnets 530 via axle 535. In the embodiment depicted in FIG. 5, the annular ring (which carries the magnets, not shown) has a diameter that will bring the magnets close to the pipeline walls. Specifically, the magnets are close enough to the pipeline wall to induce eddy currents in the pipeline when the magnets are rotated. The eddy currents cause an increase in temperature of the pipeline walls, which in turn increases the temperature of the fluids contained in the pipeline.

In each of FIGS. 1-5, a ring of permanent magnets is depicted as being disposed inside the pig, roughly located in the center of the pig. It should be understood, however, that in any of the figures, the position of the turbine and the annular ring of magnets can be switched. For example, in FIG. 1, the magnets may be positioned upstream of the pig, while the turbine is placed inside the pig. Similarly, in FIG. 5 the annular ring of magnets may be positioned downstream (in front of) the pig, while the turbine is positioned inside the pig.

In alternate embodiments, the exterior of the pig may be electromagnetically heated, rather than heating the pipeline directly. The pipeline, and the fluids therein, may be heated by the heated exterior of the pigs.

FIG. 6 depicts an embodiment of a pig 600 for removing deposits from a pipeline wall 105 that includes an electromagnetic heating system. Pig 600 includes a housing 610 and one or more annular elements 620 circumferentially mounted to the housing. The one or more annular elements engage the interior walls of pipeline 105 forming a substantially fluid impermeable seal between the pig and the pipeline, allowing a fluid differential to build between the upstream (back) of the pig and the downstream (front) of the pig. This fluid differential provides a motive force which propels the pig through the pipeline. A pig also includes one or more cleaning devices 650 coupled to an exterior of the housing and positioned such that the cleaning devices contact the pipeline wall 105. Cleaning devices 650 scrape deposits off the pipeline wall as the pig travels through the pipeline.

A turbine 630 is coupled to pig 600. In the embodiment depicted in FIG. 1, turbine 630 is placed on the upstream (back) side of the pig. Turbine 630 is coupled to one or more permanent magnets 640. A drive system is used to couple the turbine to the permanent magnets. In an embodiment, a drive system includes an axle 635 that couples the one or more permanent magnets to turbine 630.

The rotation of turbine 630 causes rotation of the magnets 630 via axle 635. Pig 600 includes a metallic component 670 which forms an exterior surface of the pig. In the embodiment depicted in FIG. 6, the magnet support has a diameter that will bring the magnets close to metallic component 670. Specifically, the magnets are close enough to metallic component 670 to induce eddy currents in the pipeline when the magnets are rotated. The eddy currents cause an increase in temperature of the metallic component, which in turn increases the temperature of the metallic component. The metallic component heats the pipeline walls and/or the fluids in the pipeline, to assist with the removal of low melting point solids.

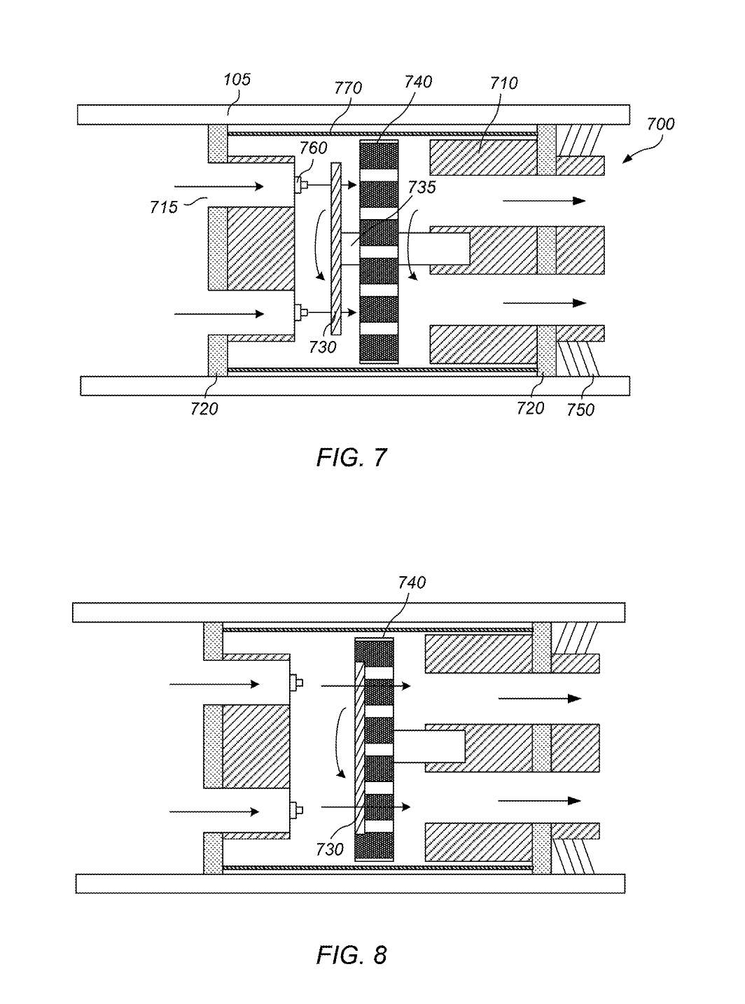

FIG. 7 depicts an alternate embodiment of a pig. Pig 700 includes a housing 710 and one or more annular elements 720 circumferentially mounted to the housing. The one or more annular elements engage the interior walls of pipeline 105 forming a substantially fluid impermeable seal between the pig and the pipeline, allowing a fluid differential to build between the upstream (back) of the pig and the downstream (front) of the pig. A pig also includes one or more cleaning devices 750 coupled to an exterior of the housing and positioned such that the cleaning devices contact the pipeline wall 105. Cleaning devices 750 scrape deposits off the pipeline wall as the pig travels through the pipeline.

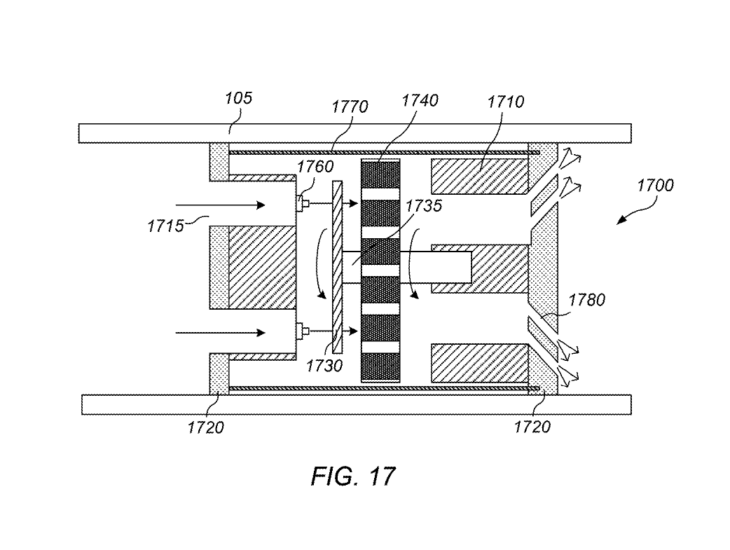

A turbine 730 is coupled to pig 700. In the embodiment depicted in FIG. 17, turbine 730 is placed within the pig. One or more passages 715 are formed in the housing 710. Fluid travelling through the pipeline enters the pig through the one or more passages. The fluid may be passed through a nozzle or jet 760 to impart a high velocity to the fluid. Thus the fluid that impinges on the turbine blade is at a high velocity causing the turbines to rotate at a higher rotational.

Pig 700 includes a metallic component 770 which forms an exterior surface of the pig. In the embodiment depicted in FIG. 7, the magnet support has a diameter that will bring the magnets close to metallic component 770. Specifically, the magnets are close enough to metallic component 770 to induce eddy currents in the pipeline when the magnets are rotated. The eddy currents cause an increase in temperature of the metallic component, which in turn increases the temperature of the metallic component. The metallic component heats the pipeline walls and/or the fluids in the pipeline, to assist with the removal of low melting point solids.

In some embodiments, a drive system coupling the turbine to the magnets is not needed. In the embodiment, depicted in FIG. 8, turbine 730 and the one or more permanent magnets 740 are integrated together. In an exemplary embodiment, turbine 730 has a smaller diameter than an annular ring which carries magnets 740. The turbine may be contacted with the annular ring of magnets such that rotation of the turbine directly causes rotation of the magnets without the need of an axle or other type of mechanical linkage. In one embodiment, an annular ring may not be used, with the magnets being placed on an outer surface of turbine 730.

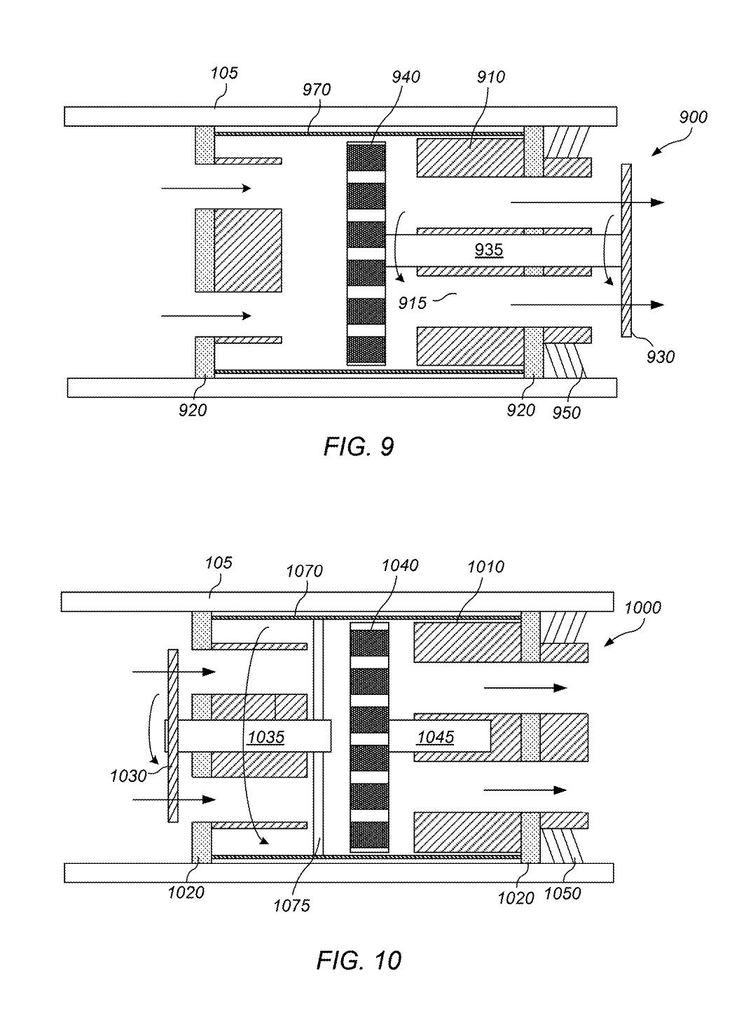

FIG. 9 depicts an alternate embodiment of a pig. Pig 900 includes a housing 910 and one or more annular elements 920 circumferentially mounted to the housing. The one or more annular elements engage the interior walls of pipeline 105 forming a substantially fluid impermeable seal between the pig and the pipeline, allowing a fluid differential to build between the upstream (back) of the pig and the downstream (front) of the pig. A pig also includes one or more cleaning devices 950 coupled to an exterior of the housing and positioned such that the cleaning devices contact the pipeline wall 105. Cleaning devices 950 scrape deposits off the pipeline wall as the pig travels through the pipeline.

A turbine 930 is coupled to pig 900. In the embodiment depicted in FIG. 9, turbine 930 is placed downstream (in front of) the pig. One or more passages 915 are formed in the housing 910. Fluid travelling through the pipeline enters the pig through the one or more passages. Fluid flowing through the one or more passages exits the pig at a velocity sufficient to cause turbine 930 to turn.

As depicted in FIG. 9, fluid flows through turbine 930 causing the turbine to rotate. The rotation of the turbine causes rotation of the magnets 930 via axle 935. In the embodiment depicted in FIG. 9, the magnet support has a diameter that will bring the magnets close to metallic component 970. Specifically, the magnets are close enough to metallic component 970 to induce eddy currents in the pipeline when the magnets are rotated. The eddy currents cause an increase in temperature of the metallic component, which in turn increases the temperature of the metallic component. The metallic component heats the pipeline walls and/or the fluids in the pipeline, to assist with the removal of low melting point solids.

In an alternate embodiment, a metallic component is rotated relative to a ring of permanent magnets to generate heat in the metallic component. An example of this embodiment is depicted in FIG. 10. FIG. 10, depicts an embodiment of a pig 1000 for removing deposits from a pipeline wall 105 that includes an electromagnetic heating system. Pig 1000 includes a housing 1010 and one or more annular elements 1020 circumferentially mounted to the housing. The one or more annular elements engage the interior walls of pipeline 105 forming a substantially fluid impermeable seal between the pig and the pipeline, allowing a fluid differential to build between the upstream (back) of the pig and the downstream (front) of the pig. This fluid differential provides a motive force which propels the pig through the pipeline. A pig also includes one or more cleaning devices 1050 coupled to an exterior of the housing and positioned such that the cleaning devices contact the pipeline wall 105. Cleaning devices 1050 scrape deposits off the pipeline wall as the pig travels through the pipeline.

A turbine 1030 is coupled to pig 1000. In the embodiment depicted in FIG. 10, turbine 1030 is placed on the upstream (back) side of the pig. Turbine 1030 is coupled to a rotatable metallic component 1070. A drive system is used to couple the turbine to the rotatable metallic component. In an embodiment, a drive system includes an axle 1035 that couples the rotatable metallic component to turbine 1030. Metallic component 1070 may be in the form of an annular ring that forms a portion of the outer surface of the pig housing and is coupled to axle 1035 by connecting member 1075.

The rotation of turbine 1030 causes rotation of the rotatable metallic component 1070 via axle 1035. Pig 1000 includes one or more permanent magnetics 1040, which are mounted to stationary support 1045 which positions the one or more permanent magnets proximate to metallic component 1040. In the embodiment depicted in FIG. 10, the one are more permanent magnets are arranged in positions that will bring the magnets close to metallic component 1070 while the metallic component is rotating. Specifically, the magnets are close enough to metallic component 1070 to induce eddy currents in the pipeline when the metallic component is rotated. The eddy currents cause an increase in temperature of the metallic component, which in turn increases the temperature of the metallic component. The metallic component heats the pipeline walls and/or the fluids in the pipeline, to assist with the removal of low melting point solids.

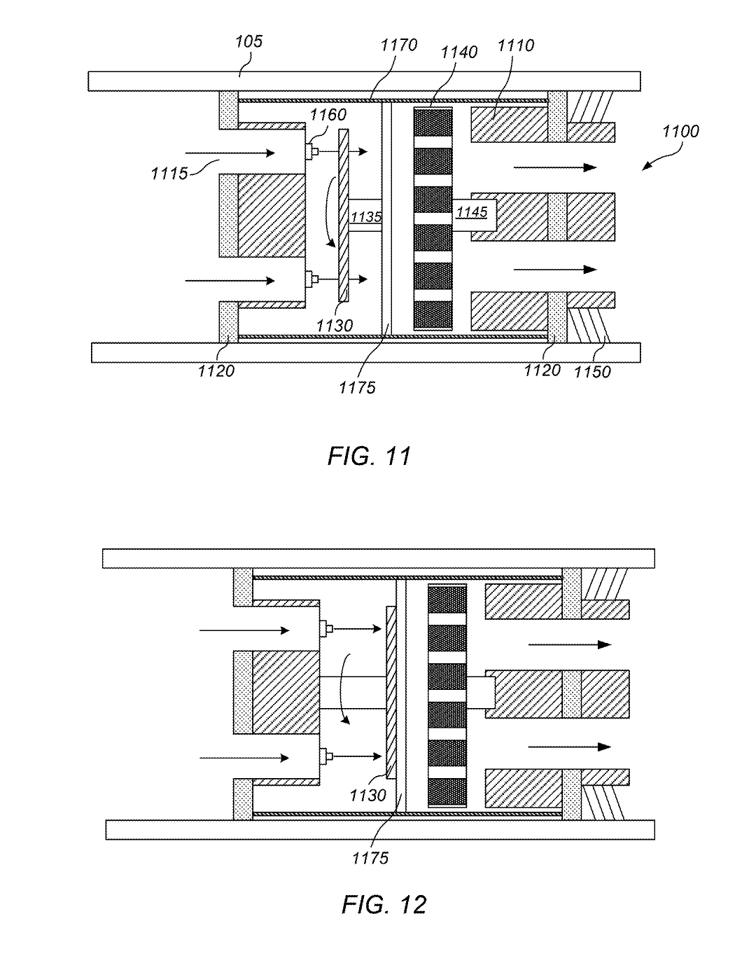

FIG. 11 depicts an alternate embodiment of a pig. Pig 1100 includes a housing 1110 and one or more annular elements 1120 circumferentially mounted to the housing. The one or more annular elements engage the interior walls of pipeline 105 forming a substantially fluid impermeable seal between the pig and the pipeline, allowing a fluid differential to build between the upstream (back) of the pig and the downstream (front) of the pig. A pig also includes one or more cleaning devices 1150 coupled to an exterior of the housing and positioned such that the cleaning devices contact the pipeline wall 105. Cleaning devices 1150 scrape deposits off the pipeline wall as the pig travels through the pipeline.

A turbine 1130 is coupled to pig 1100. In the embodiment depicted in FIG. 11, turbine 1130 is placed within the pig. One or more passages 1115 are formed in the housing 1110. Fluid travelling through the pipeline enters the pig through the one or more passages. The fluid may be passed through a nozzle or jet 1160 to impart a high velocity to the fluid. Thus the fluid that impinges on the turbine blade is at a high velocity causing the turbines to rotate at a higher rotational.

As depicted in FIG. 11, fluid flows through turbine 1130 causing the turbine to rotate. Turbine 1130 is coupled to a rotatable metallic component 1170. A drive system is used to couple the turbine to the rotatable metallic component. In an embodiment, a drive system includes an axle 1135 that couples the rotatable metallic component to turbine 1130. Metallic component 1170 may be in the form of an annular ring that forms a portion of the outer surface of the pig housing and is coupled to axle 1135 by connecting member 1175.

The rotation of turbine 1130 causes rotation of the rotatable metallic component 1170 via axle 1135. Pig 1100 includes one or more permanent magnetics 1140, which are mounted to stationary support 1145 which positions the one or more permanent magnets proximate to metallic component 1140. In the embodiment depicted in FIG. 11, the one are more permanent magnets are arranged in positions that will bring the magnets close to metallic component 1170 while the metallic component is rotating. Specifically, the magnets are close enough to metallic component 1170 to induce eddy currents in the pipeline when the metallic component is rotated. The eddy currents cause an increase in temperature of the metallic component, which in turn increases the temperature of the metallic component. The metallic component heats the pipeline walls and/or the fluids in the pipeline, to assist with the removal of low melting point solids.

In some embodiments, a drive system coupling the turbine to rotatable metallic component 1170 is not needed. In the embodiment, depicted in FIG. 12, turbine 1130 and the connecting member 1175 are integrated together. The turbine may be contacted with the connecting member 1175 such that rotation of the turbine directly causes rotation of the magnets without the need of an axle or other type of mechanical linkage. In one embodiment, an annular ring may not be used, with the rotatable metallic component 1170 is connected to an outer surface of turbine 1130.

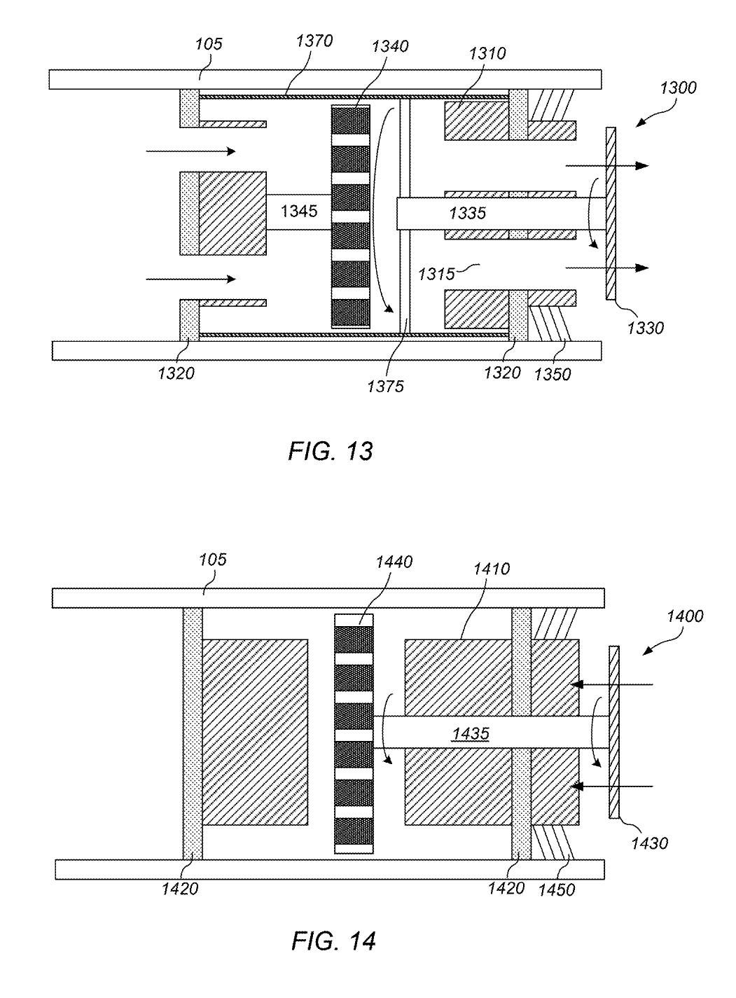

FIG. 13 depicts an alternate embodiment of a pig. Pig 1300 includes a housing 1310 and one or more annular elements 1320 circumferentially mounted to the housing. The one or more annular elements engage the interior walls of pipeline 105 forming a substantially fluid impermeable seal between the pig and the pipeline, allowing a fluid differential to build between the upstream (back) of the pig and the downstream (front) of the pig. A pig also includes one or more cleaning devices 1350 coupled to an exterior of the housing and positioned such that the cleaning devices contact the pipeline wall 105. Cleaning devices 1350 scrape deposits off the pipeline wall as the pig travels through the pipeline.

A turbine 1330 is coupled to pig 1300. In the embodiment depicted in FIG. 13, turbine 1330 is placed downstream (in front of) the pig. One or more passages 1315 are formed in the housing 1310. Fluid travelling through the pipeline enters the pig through the one or more passages. Fluid flowing through the one or more passages exits the pig at a velocity sufficient to cause turbine 1330 to turn.

As depicted in FIG. 13, fluid flows through turbine 1330 causing the turbine to rotate. Turbine 1330 is coupled to a rotatable metallic component 1370. A drive system is used to couple the turbine to the rotatable metallic component. In an embodiment, a drive system includes an axle 1335 that couples the rotatable metallic component to turbine 1330. Metallic component 1370 may be in the form of an annular ring that forms a portion of the outer surface of the pig housing and is coupled to axle 1335 by connecting member 1375.

The rotation of turbine 1330 causes rotation of the rotatable metallic component 1370 via axle 1335. Pig 1300 includes one or more permanent magnetics 1340, which are mounted to stationary support 1345 which positions the one or more permanent magnets proximate to metallic component 1340. In the embodiment depicted in FIG. 13, the one are more permanent magnets are arranged in positions that will bring the magnets close to metallic component 1370 while the metallic component is rotating. Specifically, the magnets are close enough to metallic component 1370 to induce eddy currents in the pipeline when the metallic component is rotated. The eddy currents cause an increase in temperature of the metallic component, which in turn increases the temperature of the metallic component. The metallic component heats the pipeline walls and/or the fluids in the pipeline, to assist with the removal of low melting point solids.

In some embodiments, the pig is substantially impervious to the fluids flowing through the pipeline such that the interior of the pig housing is substantially free of fluids. In such embodiments, the fluid flow required to drive the turbine is obtained by the forward movement of the pig through the pipeline. Such movement creates a fluid flow toward the downstream (front) side of the pig and can be converted to rotational motion via a turbine coupled to the downstream (front) side of the pig.

FIG. 14 depicts an embodiment of a sealed pig. Pig 1400 includes a housing 1410 and one or more annular elements 1420 circumferentially mounted to the housing. The one or more annular elements engage the interior walls of pipeline 105 forming a substantially fluid impermeable seal between the pig and the pipeline, allowing a fluid differential to build between the upstream (back) of the pig and the downstream (front) of the pig. Annular elements 1420, in this embodiment, do not include any ports or passages that would allow fluid to enter the pig. Thus annular elements 1420 substantially prevent pipeline fluid from entering the interior of the pig.

A pig also includes one or more cleaning devices 1450 coupled to an exterior of the housing and positioned such that the cleaning devices contact the pipeline wall 105. Cleaning devices 1450 scrape deposits off the pipeline wall as the pig travels through the pipeline.

A turbine 1430 is coupled to pig 1400. In the embodiment depicted in FIG. 14, turbine 1430 is placed downstream (in front of) the pig. As the pigs is conveyed down the pipeline, fluids in the pipeline move toward turbine 1430, causing the turbine to rotate.

As depicted in FIG. 14, fluid flows through turbine 1430 causing the turbine to rotate. The rotation of the turbine causes rotation of the magnets 1430 via axle 1435. In the embodiment depicted in FIG. 14, the annular ring (which carries the magnets, not shown) has a diameter that will bring the magnets close to the pipeline walls. Specifically, the magnets are close enough to the pipeline wall to induce eddy currents in the pipeline when the magnets are rotated. The eddy currents cause an increase in temperature of the pipeline walls, which in turn increases the temperature of the fluids contained in the pipeline.

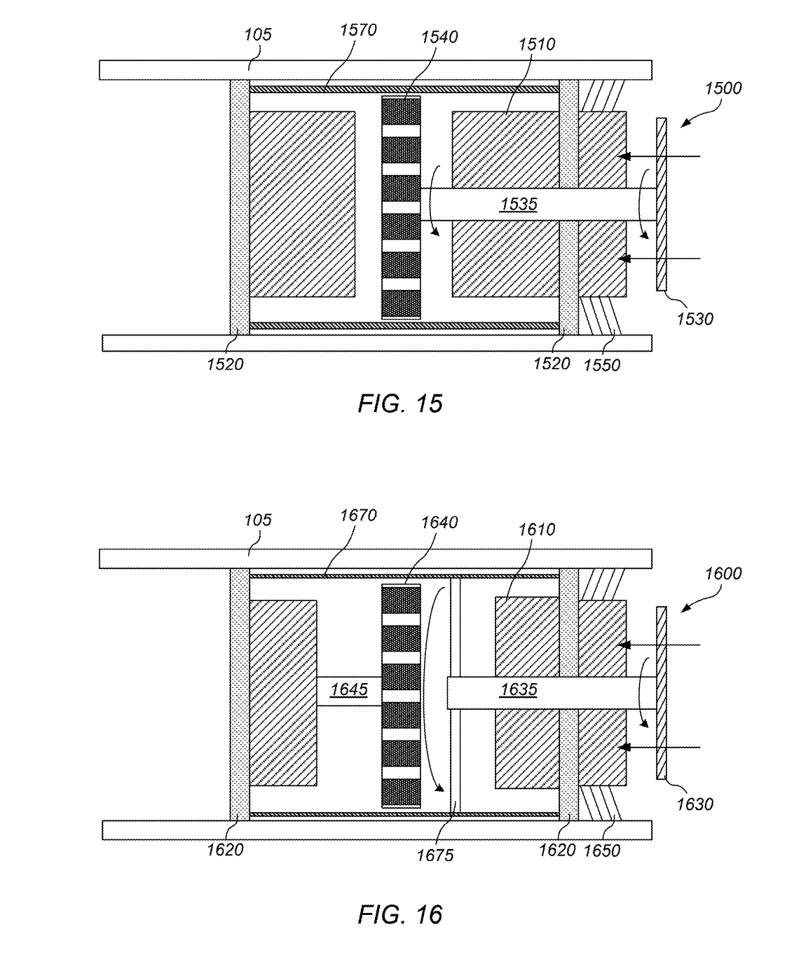

FIG. 15 depicts an alternate embodiment of a pig. Pig 1500 includes a housing 1510 and one or more annular elements 1520 circumferentially mounted to the housing. The one or more annular elements engage the interior walls of pipeline 105 forming a substantially fluid impermeable seal between the pig and the pipeline, allowing a fluid differential to build between the upstream (back) of the pig and the downstream (front) of the pig. A pig also includes one or more cleaning devices 1550 coupled to an exterior of the housing and positioned such that the cleaning devices contact the pipeline wall 105. Cleaning devices 1550 scrape deposits off the pipeline wall as the pig travels through the pipeline.

A turbine 1530 is coupled to pig 1500. In the embodiment depicted in FIG. 15, turbine 1530 is placed downstream (in front of) the pig. As the pigs is conveyed down the pipeline, fluids in the pipeline move toward turbine 1530, causing the turbine to rotate.

As depicted in FIG. 15, fluid flows through turbine 1530 causing the turbine to rotate. The rotation of the turbine causes rotation of the magnets 1530 via axle 1535. In the embodiment depicted in FIG. 15, the magnet support has a diameter that will bring the magnets close to metallic component 1570. Specifically, the magnets are close enough to metallic component 1570 to induce eddy currents in the pipeline when the magnets are rotated. The eddy currents cause an increase in temperature of the metallic component, which in turn increases the temperature of the metallic component. The metallic component heats the pipeline walls and/or the fluids in the pipeline, to assist with the removal of low melting point solids.

FIG. 16 depicts an alternate embodiment of a pig. Pig 1600 includes a housing 1610 and one or more annular elements 1620 circumferentially mounted to the housing. The one or more annular elements engage the interior walls of pipeline 105 forming a substantially fluid impermeable seal between the pig and the pipeline, allowing a fluid differential to build between the upstream (back) of the pig and the downstream (front) of the pig. A pig also includes one or more cleaning devices 1650 coupled to an exterior of the housing and positioned such that the cleaning devices contact the pipeline wall 105. Cleaning devices 1650 scrape deposits off the pipeline wall as the pig travels through the pipeline.

A turbine 1630 is coupled to pig 1600. In the embodiment depicted in FIG. 16, turbine 1630 is placed downstream (in front of) the pig. As the pigs is conveyed down the pipeline, fluids in the pipeline move toward turbine 1630, causing the turbine to rotate.

As depicted in FIG. 16, fluid flows through turbine 1630 causing the turbine to rotate.

Turbine 1630 is coupled to a rotatable metallic component 1670. A drive system is used to couple the turbine to the rotatable metallic component. In an embodiment, a drive system includes an axle 1635 that couples the rotatable metallic component to turbine 1630. Metallic component 1670 may be in the form of an annular ring that forms a portion of the outer surface of the pig housing and is coupled to axle 1635 by connecting member 1675.

The rotation of turbine 1630 causes rotation of the rotatable metallic component 1670 via axle 1635. Pig 1600 includes one or more permanent magnetics 1640, which are mounted to stationary support 1645 which positions the one or more permanent magnets proximate to metallic component 1640. In the embodiment depicted in FIG. 16, the one are more permanent magnets are arranged in positions that will bring the magnets close to metallic component 1670 while the metallic component is rotating. Specifically, the magnets are close enough to metallic component 1670 to induce eddy currents in the pipeline when the metallic component is rotated. The eddy currents cause an increase in temperature of the metallic component, which in turn increases the temperature of the metallic component. The metallic component heats the pipeline walls and/or the fluids in the pipeline, to assist with the removal of low melting point solids.

FIG. 17 depicts an alternate embodiment of a pig. Pig 1700 includes a housing 1710 and one or more annular elements 1720 circumferentially mounted to the housing. The one or more annular elements engage the interior walls of pipeline 105 forming a substantially fluid impermeable seal between the pig and the pipeline, allowing a fluid differential to build between the upstream (back) of the pig and the downstream (front) of the pig. A turbine 1730 is coupled to pig 1700. In the embodiment depicted in FIG. 17, turbine 1730 is placed within the pig. One or more passages 1715 are formed in the housing 1710. Fluid travelling through the pipeline enters the pig through the one or more passages. The fluid may be passed through a nozzle or jet 1760 to impart a high velocity to the fluid. Thus the fluid that impinges on the turbine blade is at a high velocity causing the turbines to rotate at a higher rotational.

Pig 1700 includes a metallic component 1770 which forms an exterior surface of the pig. In the embodiment depicted in FIG. 17, the magnet support has a diameter that will bring the magnets close to metallic component 1770. Specifically, the magnets are close enough to metallic component 1770 to induce eddy currents in the pipeline when the magnets are rotated. The eddy currents cause an increase in temperature of the metallic component, which in turn increases the temperature of the metallic component. The metallic component heats the pipeline walls and/or the fluids in the pipeline, to assist with the removal of low melting point solids.

Fluids within the interior of pig 1700 are also heated by the inductively heated metallic component 1770. Thus, as fluids pass through the interior of the pig the temperature of the fluids is raised. In the embodiment depicted in FIG. 17, a plurality of fluid jets are created by providing one or more narrow passages 1780 through which fluid in the interior of pig 1700 is ejected. These passages may be angled, as depicted, to direct high velocity, heated fluid from the interior of the pig toward the pipeline walls. In this manner the combination of hot fluids and the force of the high velocity fluid improve the removal of deposits on the pipe walls. It should be understood that the use of high velocity, heated fluids to aid in the removal of deposits on pipeline walls can be implemented in any of the previously described embodiments.

The pigs depicted in FIGS. 1-17 are generally depicted as having internal conduits and fluid inlet and outlet ports having a generally consistent diameter. It should be understood, however, that the rate of fluid flowing through the pig can be controlled by adjusting the size of the openings of the fluid inlet and outlet ports and/or the diameter of the internal fluid conduits. For example, as shown in FIG. 3, the rate of fluid flowing through the pig is increased by coupling nozzle 360 to the inlet conduit, thus creating a restricted entry port for the incoming fluid. In the example depicted in FIG. 17, the exit ports 1780 are smaller than the internal fluid conduits. This increases the fluid velocity as the fluid exits the pig.

The electromagnetic pig can be used in the normal mode by launching it with a pig launcher and collecting it in a pig catcher, as is standard practice. If additional heating is needed, the pig could be used to preheat some fluid ahead of the pig prior to launch, by holding it stationary for a short or a long time while allowing the fluid to flow through it, turning the magnets and heating up the pipe and the fluid going through it. The fluid and the pipe ahead of the pig will now be preheated prior to the pig being launched.

The amount of heat generated by an electromagnetic pig is given by,

P=η·ρ·g·h·\dot{q}

### Where:

P=power (J/s or watts)

η=turbine efficiency

ρ=density of fluid (kg/m³)

g=acceleration of gravity (9.81 m/s²)

h=head (m). The total head equals the pressure head plus velocity head.

\dot{q}=flow rate (m³/s)

For a typical set of conditions the power generated by the induction heating can vary widely and has been estimated to vary from 0.1 KW to over 1 MW depending mainly on the pressure differential across the pig, the pipeline diameter and the flow rate of fluid through the pipeline. This is more than sufficient to heat up the pipeline and the fluids flowing through it in the immediate vicinity of the pig.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. An electromagnetic device capable of removing deposits from pipelines, comprising:
a cylindrical housing
one or more annular elements circumferentially mounted to the housing, wherein, during use, the one or more annular elements engage the interior walls of the pipeline;
a turbine coupled to the cylindrical housing, wherein the turbine rotates in response to fluids from the pipeline contacting the cylindrical housing; and
one or more permanent magnets coupled to the turbine.

2. The device of claim 1, wherein, during use, the permanent magnets are rotated in a manner such that a current is generated in the pipeline walls proximate to the device, causing an increase in temperature of the pipeline walls and the fluids therein.

3. The device of claim 2, further comprising a drive mechanism coupled to the turbine, wherein the drive mechanism translates the rotational motion of the turbine into rotational movement of the one or more permanent magnets.

4. The device of claim 1, further comprising a metallic component magnetically coupled to the one or more permanent magnets, wherein the during use, the permanent magnets rotate with respect to the metallic component such that a current is generated in the metallic component, causing the temperature of the metallic component to increase.

5. The device of claim 4, wherein the metallic component comprises an outer surface configured to engage the pipeline walls, wherein the outer surface of the metallic component scrapes deposits off of the pipeline walls as the electromagnetic pig moves through the pipeline.

6. The device of claim 4 or 5, further comprising a drive mechanism coupled to the turbine, wherein the drive mechanism translates the rotational motion of the turbine into rotational movement of the metallic component.

7. The device of any one of claims 1-6, wherein the one or more permanent magnets comprises a plurality of permanent magnets placed in a cylindrical arrangement having alternately placed north-south poles.

8. The device of any one of claims 1-6, wherein the one or more permanent magnets comprises a plurality of permanent magnets placed in a Hallbach array.

9. The device of any one of claims 1-8, wherein the turbine is an impulse turbine.

10. The device of any one of claims 1-8, wherein the turbine is a reaction turbine.

11. The device of any one of claims 1-10, wherein the one or more annular elements engage the interior walls of the pipeline to create a substantially fluid impermeable seal between the cylindrical housing and the pipeline walls.

12. The device of any one of claims 1-11, wherein the cylindrical housing comprises an internal cavity passing longitudinally through the cylindrical housing, wherein fluid passing through the pipeline passes through the internal cavity during use.

13. The device of claim 12, wherein the turbine is positioned in or proximate to the internal cavity such that fluid flowing through the internal cavity impinges on one or more blades of the turbine to cause rotation of the turbine.

14. The device of any one of claims 1-13, wherein the turbine is coupled to the front of the cylindrical housing wherein forward movement of the movement of the electromagnetic pig through the pipeline causes fluid in the pipeline to impinge on one or more blades of the turbine to cause rotation of the turbine.

15. The device of any one of claims 1-14, wherein the turbine is coupled to the back of the cylindrical housing wherein movement of fluid through or around the electromagnetic pig causes fluid in the pipeline to impinge on one or more blades of the turbine to cause rotation of the turbine.

16. A method of removing deposits from a pipeline comprising:
placing an electromagnetic device as described in any one of claims 1-15 into an oil or gas pipeline;
applying fluid to the electromagnetic device causing the electromagnetic device to be moved through the pipeline, wherein the movement of the device or the movement of the fluid proximate to the device, causes the turbines to rotate.
